(19) United States
(12) Patent Application Publication
(10) Pub. No.: US 2014/0028274 A1
(43) Pub. Date: Jan. 30, 2014

(54) REGULATOR

(71) Applicant: Seiko Instruments Inc., Chiba-shi (JP)

(72) Inventor: Daisuke MURAOKA, Chiba-shi (JP)

(73) Assignee: Seiko Instruments Inc., Chiba-shi (JP)

(21) Appl. No.: 13/953,257

(22) Filed: Jul. 29, 2013

(30) Foreign Application Priority Data
Jul. 30, 2012 (JP) 2012-168799

(51) Int. Cl. G05F 1/575

(52) U.S. Cl. CPC G05F 1/575
USPC 323/280

(57) ABSTRACT

Provided is a regulator configured to output a stable voltage even when a power supply voltage fluctuates suddenly. The regulator includes: a reference voltage circuit; a differential amplifier; a depletion type NMOS transistor; and a bleeder circuit, in which a power supply terminal of the differential amplifier is connected to an output terminal of the regulator. Further, a power supply terminal of the reference voltage circuit is connected to the output terminal of the regulator.

### RELATED APPLICATIONS

This application claims priority under 35 U.S.C. §119 to Japanese Patent Application No. 2012-168799 filed on Jul. 30, 2012, the entire content of which is hereby incorporated by reference.

### BACKGROUND OF THE INVENTION

1. Field of the Invention

The present invention relates to a regulator to be used for supplying desired stable power to an electronic circuit such as a sensor device.

2. Description of the Related Art

Regulators are used for supplying stable power to various electronic devices. The regulator is used, for example, in an in-vehicle sensor device that is driven by using a high voltage as power supply, for the purpose of supplying a stable low voltage as power supply to a signal processing circuit in the in-vehicle sensor device.

As one example of the above-mentioned regulator, particularly a regulator in which parasitic oscillation is not liable to occur, a configuration illustrated in FIG. 3 is devised (see, for example, Japanese Patent Application Laid-open No. 2008-192083).

The conventional regulator includes a reference voltage circuit 1, a differential amplifier 2, a depletion type NMOS transistor 3, a first resistor R1, and a second resistor R2. A positive electrode of the reference voltage circuit 1, a positive electrode of the differential amplifier 2, and a drain of the depletion type NMOS transistor 3 are connected to a power supply terminal. A negative electrode of the reference voltage circuit 1, a negative electrode of the differential amplifier 2, and one end of the second resistor R2 are connected to a ground terminal. The first resistor R1 has one end connected to a source of the depletion type NMOS transistor 3 and the other end connected to the other end of the second resistor R2. The differential amplifier 2 has a first input connected to an output terminal of the reference voltage circuit 1, a second input connected to a node between the first resistor R1 and the second resistor R2, and an output terminal connected to a gate of the depletion type NMOS transistor 3.

In the regulator having the above-mentioned configuration, even when a difference between an output voltage Vout of the regulator and an input power supply voltage Vin is small, parasitic oscillation is not liable to occur and a stable voltage is output.

However, in the conventional regulator, there is a problem that, when the power supply voltage Vin to be input fluctuates, the output voltage Vout, which is supposed to be output stably, fluctuates. When the power supply voltage Vin to be input fluctuates, power supply of the differential amplifier 2 also fluctuates, and therefore an output voltage Vg of the differential amplifier 2 fluctuates as well. As a result, the output voltage Vout of the regulator fluctuates.

### SUMMARY OF THE INVENTION

It is an object of the present invention to provide a regulator configured to output a stable output voltage Vout even when a power supply voltage Vin to be input fluctuates suddenly.

In order to solve the above-mentioned conventional problem, the regulator according to the present invention has the following configuration.

The regulator includes: a reference voltage circuit; a differential amplifier; a depletion type NMOS transistor; and a bleeder circuit, in which a power supply terminal of the differential amplifier is connected to an output terminal of the regulator. Further, a power supply terminal of the reference voltage circuit is connected to the output terminal of the regulator.

According to the regulator of the present invention, the adverse effect of the fluctuation of the input power supply voltage on the output voltage is suppressed by a simple circuit configuration.

### BRIEF DESCRIPTION OF THE DRAWINGS

In the accompanying drawings:

FIG. 1 is a circuit diagram of a regulator according to an embodiment of the present invention;

FIG. 2 is a circuit diagram of another example of the regulator according to the embodiment of the present invention; and

FIG. 3 is a circuit diagram of a conventional regulator.

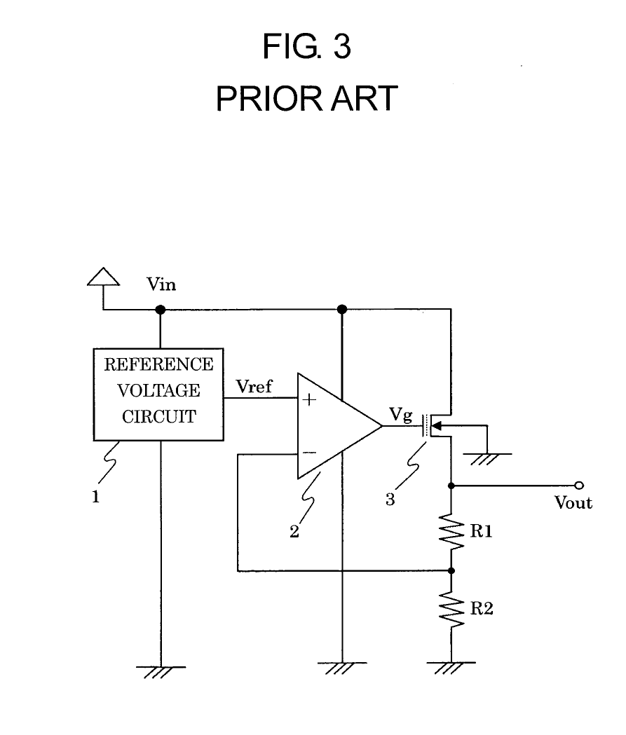

### DETAILED DESCRIPTION OF THE PREFERRED EMBODIMENT

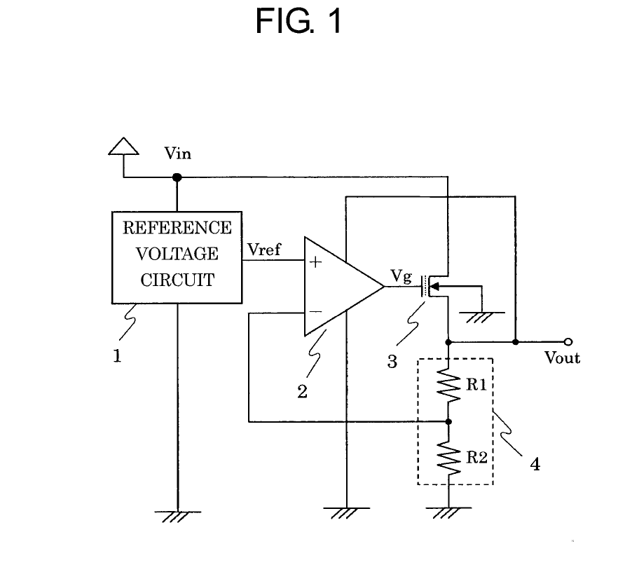

FIG. 1 is a circuit diagram of a regulator according to an embodiment of the present invention. The regulator according to the embodiment of the present invention includes a reference voltage circuit 1, a differential amplifier 2, a depletion type NMOS transistor 3, and a voltage dividing circuit 4.

The reference voltage circuit 1 has a positive electrode connected to a power supply terminal and a negative electrode connected to a ground terminal. The differential amplifier 2 has a non-inverting input terminal connected to an output terminal of the reference voltage circuit 1, an inverting input terminal connected to an output terminal of the voltage dividing circuit 4, a positive electrode connected to an output terminal of the regulator, and a negative electrode connected to the ground terminal. The depletion type NMOS transistor 3 has a drain connected to the power supply terminal, a source connected to the output terminal of the regulator, and a gate connected to an output terminal of the differential amplifier 2. The voltage dividing circuit 4 is connected between the output terminal of the regulator and the ground terminal.

An output voltage Vout of the regulator according to the embodiment of the present invention is determined as expressed in Expression 1.

Vout=Vref×(R1+R2)/R2 (1)

where Vref represents a reference voltage, and R1 and R2 represent resistance values of resistors constituting the voltage dividing circuit.

In the regulator according to the embodiment of the present invention, the positive electrode of the differential amplifier 2 is connected to the output terminal of the regulator. In other words, the differential amplifier 2 operates by using the output voltage Vout of the regulator as power supply. Therefore, even when a power supply voltage Vin fluctuates suddenly, an output voltage Vg of the differential amplifier 2 does not fluctuate.

As described above, in the regulator according to the embodiment of the present invention, even when the power supply voltage Vin fluctuates suddenly, the stable output voltage Vout is output.

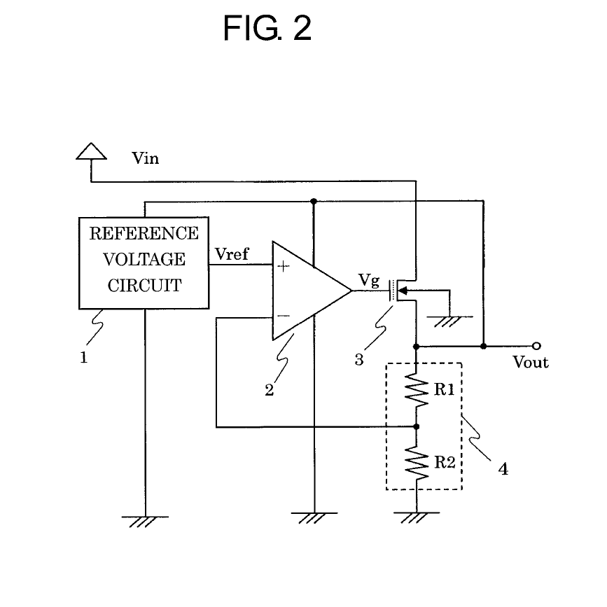

FIG. 2 is a circuit diagram of another example of the regulator according to the embodiment of the present invention.

The regulator of FIG. 2 has a configuration in which the positive electrode of the reference voltage circuit 1 is also connected to the output terminal of the regulator.

The reference voltage circuit is designed to output a fixed voltage as the reference voltage Vref regardless of the power supply voltage. In the configuration as illustrated in FIG. 2, the reference voltage circuit is even less likely to be affected by the fluctuation of the power supply voltage. Therefore, the regulator of FIG. 2 outputs the stable output voltage Vout even when the power supply voltage Vin fluctuates suddenly.

What is claimed is:

1. A regulator, comprising:
a reference voltage circuit;
a depletion type NMOS transistor including a drain connected to a power supply terminal and a source connected to an output terminal of the regulator;
a voltage dividing circuit connected between the output terminal of the regulator and a ground terminal; and
a differential amplifier including a first input terminal connected to an output terminal of the reference voltage circuit, a second input terminal connected to an output terminal of the voltage dividing circuit, a positive electrode connected to the output terminal of the regulator, a negative electrode connected to the ground terminal, and an output terminal connected to a gate of the depletion type NMOS transistor.

2. A regulator according to claim 1, wherein the reference voltage circuit includes a positive electrode connected to the output terminal of the regulator and a negative electrode connected to the ground terminal.
